(19) United States
(12) Patent Application Publication
(10) Pub. No.: US 2016/0085174 A1
(43) Pub. Date: Mar. 24, 2016

(54) OPTICAL DEVICE AND METHOD OF MANUFACTURING THE SAME

(71) Applicant: CANON KABUSHIKI KAISHA, Ohta-ku, Tokyo (JP)

(72) Inventors: Masayasu Teramura, Utsunomiya-shi (JP); Takeyoshi Saiga, Tokyo (JP); Yu Miyajima, Utsunomiya-shi (JP)

(21) Appl. No.: 14/891,182

(22) PCT Filed: Jul. 9, 2014
(86) PCT No.: PCT/JP2014/068842

§ 371 Date: Nov. 13, 2015

(30) Foreign Application Priority Data
Jul. 19, 2013 (JP) 2013-150264

(51) Int. Cl. B41J 2/385

(52) U.S. Cl. CPC G03G 15/0415

(57) ABSTRACT

Provided is an optical device capable of adjusting astigmatism due to a manufacturing error to attain excellent imaging performance while securing optical efficiency. The optical device includes: an imaging optical system including multiple lens arrays in an optical axis direction, the multiple lens arrays each including multiple lens units arrayed in a first direction perpendicular to the optical axis direction; a light source including multiple light-emitting points arrayed in the first direction; and first changing means for changing a first distance in the optical axis direction between the light source and one of the lens arrays, closest to the light source. The imaging optical system is configured to image the light source at equal magnification as an erecting image within a first cross-sectional plane, and image, within a second cross-sectional plane perpendicular to the first direction, the light source at a different magnification than at the first cross-sectional plane.

### TECHNICAL FIELD

The present invention relates to an optical device, which is suited as an optical device to be mounted on, for example, an image forming apparatus and an image reading apparatus.

### BACKGROUND ART

In recent years, as an optical device to be mounted on an image forming apparatus and an image reading apparatus such as a printer and a copying machine, there has been developed an optical device including a multi-lens array (hereinafter referred to also as “MLA”) having multiple lens units arranged at regular intervals in a first direction perpendicular to an optical axis direction. When the MLA is applied in the optical device, a light source array (such as an LED array) is provided, which is constructed by arranging multiple light-emitting points at regular intervals in the first direction so as to correspond to the MLA, and the MLA and the light source array are held by a housing. In this optical device, the number of components can be reduced, to thereby realize downsizing of the device and reduction in cost. On the other hand, the challenge for the optical device including the MLA is, however, to enhance both resolution and optical efficiency.

Patent Literature 1 discloses an optical device including an MLA configured to image an object at equal magnification as an erecting image within a first cross-sectional plane including the optical axis direction and the first direction, and to image the object at equal magnification as an inverted image within a second cross-sectional plane including the optical axis direction and a second direction perpendicular to both the optical axis direction and the first direction. In the optical device disclosed in Patent Literature 1, the power of the lenses within the second cross-sectional plane can be reduced as compared to the system configured to image an object at equal magnification as an erecting image within both the cross-sectional planes, and hence this optical device is advantageous in enhancing both the resolution and the optical efficiency.

Further, in the related-art optical device using the lens array, the image quality varies depending on positional accuracy of the lens array. In view of this, there is known a lens position adjusting method for an LED print head, which involves adjusting distances among the lens array, the light source, and a light receiving element.

### CITATION LIST

### Patent Literature

PTL 1: Japanese Patent Application Laid-Open No. S63-274915

### SUMMARY OF INVENTION

### Technical Problem

In the optical device disclosed in Patent Literature 1, the imaging magnification within the first cross-sectional plane is different from the imaging magnification within the second cross-sectional plane (that is, +1× and −1×). Therefore, when any manufacturing error occurs in the optical member, astigmatism occurs, in which the imaging positions within the respective planes are displaced from each other.

In the above-mentioned lens position adjusting method for an LED print head, astigmatism can be adjusted when the imaging magnification within the first cross-sectional plane and the imaging magnification within the second cross-sectional plane are both +1×, but cannot be adjusted when both the imaging magnifications are different from each other.

In view of the above, the present invention provides an optical device capable of adjusting astigmatism to attain excellent imaging performance while securing optical efficiency, including at least two MLAs arranged so as to image an object at a first magnification as an erecting image within a first cross-sectional plane, and to image the object at a magnification different from the first magnification within a second cross-sectional plane.

### Solution Problem

According to one embodiment of the present invention, there is provided an optical device, including: an imaging optical system including multiple lens arrays in an optical axis direction, the multiple lens arrays each including multiple lens units arrayed in a first direction perpendicular to the optical axis direction; a light source including multiple light-emitting points arrayed in the first direction; and first changing means for changing a first distance in the optical axis direction between the light source and one of the multiple lens arrays, which is closest to the light source, the imaging optical system being configured to: image the light source at equal magnification as an erecting image within a first cross-sectional plane including the optical axis direction and the first direction; and image, within a second cross-sectional plane perpendicular to the first direction, the light source at a magnification different from the magnification within the first cross-sectional plane.

### Advantageous Effects of Invention

According to one embodiment of the present invention, it is possible to adjust the astigmatism to attain the excellent imaging performance while securing the optical efficiency in the optical device including the at least two MLAs arranged so as to image the object at the first magnification as the erecting image within the first cross-sectional plane, and to image the object at the magnification different from the first magnification within the second cross-sectional plane.

Further features of the present invention will become apparent from the following description of exemplary embodiments with reference to the attached drawings.

### BRIEF DESCRIPTION OF DRAWINGS

FIG. 1A is a schematic XY cross-sectional view illustrating a main part of an optical device 100 according to a first embodiment of the present invention.

FIG. 1B is a schematic XZ cross-sectional view illustrating a main part of the optical device 100 according to the first embodiment of the present invention.

FIG. 1C is a schematic YZ cross-sectional view illustrating a main part of the optical device 100 according to the first embodiment of the present invention.

FIG. 2A is a view illustrating how a light-emitting point 101a at an on-axis object height is imaged on a light receiving surface 105 within an XY cross-sectional plane under an ideal state.

FIG. 2B is a view illustrating how a light-emitting point 101b at an intermediate object height is imaged on the light receiving surface 105 within the XY cross-sectional plane under the ideal state.

FIG. 2C is a view illustrating how the light-emitting point 101a or 101b at the on-axis object height or the intermediate object height is imaged on the light receiving surface 105 within an XZ cross-sectional plane under the ideal state.

FIG. 2D is a view illustrating how the light-emitting point 101a at the on-axis object height is imaged on the light receiving surface 105 within the XY cross-sectional plane in a case where an imaging unit 102 is displaced in a +X direction.

FIG. 2E is a view illustrating how the light-emitting point 101b at the intermediate object height is imaged on the light receiving surface 105 within the XY cross-sectional plane in the case where the imaging unit 102 is displaced in the +X direction.

FIG. 2F is a view illustrating how the light-emitting point 101a or 101b at the on-axis object height or the intermediate object height is imaged on the light receiving surface 105 within the XZ cross-sectional plane in the case where the imaging unit 102 is displaced in the +X direction.

FIG. 3A is a view illustrating how the light-emitting point 101a at the on-axis object height is imaged on the light receiving surface 105 within the XY cross-sectional plane in a case where the light source 101 is displaced in a −X direction.

FIG. 3B is a view illustrating how the light-emitting point 101b at the intermediate object height is imaged on the light receiving surface 105 within the XY cross-sectional plane in the case where the light source 101 is displaced in the −X direction.

FIG. 3C is a view illustrating how the light-emitting point 101a or 101b at the on-axis object height or the intermediate object height is imaged on the light receiving surface 105 within the XZ cross-sectional plane in the case where the light source 101 is displaced in the −X direction.

FIG. 4 is a schematic view illustrating a main part of the optical device 100 according to the first embodiment of the present invention, including means for adjusting astigmatism.

FIG. 5A is a graph showing defocus characteristics of contrasts in the optical device 100 according to the first embodiment of the present invention.

FIG. 5B is a graph showing defocus characteristics of contrasts in the optical device 100 according to the first embodiment of the present invention.

FIG. 5C is a graph showing defocus characteristics of contrasts in the optical device 100 according to the first embodiment of the present invention.

FIG. 5D is a graph showing defocus characteristics of contrasts in the optical device 100 according to the first embodiment of the present invention.

FIG. 5E is a graph showing defocus characteristics of contrasts in the optical device 100 according to the first embodiment of the present invention.

FIG. 5F is a graph showing defocus characteristics of contrasts in the optical device 100 according to the first embodiment of the present invention.

FIG. 6A is a schematic XY cross-sectional view illustrating a main part of an optical device 600 according to a second embodiment of the present invention.

FIG. 6B is a schematic XZ cross-sectional view illustrating a main part of the optical device 600 according to the second embodiment of the present invention.

FIG. 6C is a schematic YZ cross-sectional view illustrating a main part of the optical device 600 according to the second embodiment of the present invention.

FIG. 7A is a graph showing defocus characteristics of contrasts in the optical device 600 according to the second embodiment of the present invention.

FIG. 7B is a graph showing defocus characteristics of contrasts in the optical device 600 according to the second embodiment of the present invention.

FIG. 7C is a graph showing defocus characteristics of contrasts in the optical device 600 according to the second embodiment of the present invention.

FIG. 7D is a graph showing defocus characteristics of contrasts in the optical device 600 according to the second embodiment of the present invention.

FIG. 7E is a graph showing defocus characteristics of contrasts in the optical device 600 according to the second embodiment of the present invention.

FIG. 7F is a graph showing defocus characteristics of contrasts in the optical device 600 according to the second embodiment of the present invention.

FIG. 8A is a schematic XY cross-sectional view illustrating a main part of an optical device 1200 according to a third embodiment of the present invention.

FIG. 8B is a schematic XZ cross-sectional view illustrating a main part of the optical device 1200 according to the third embodiment of the present invention.

FIG. 8C is a schematic YZ cross-sectional view illustrating a main part of the optical device 1200 according to the third embodiment of the present invention.

FIG. 9A is a graph showing defocus characteristics of contrasts in the optical device 1200 according to the third embodiment of the present invention.

FIG. 9B is a graph showing defocus characteristics of contrasts in the optical device 1200 according to the third embodiment of the present invention.

FIG. 9C is a graph showing defocus characteristics of contrasts in the optical device 1200 according to the third embodiment of the present invention.

FIG. 9D is a graph showing defocus characteristics of contrasts in the optical device 1200 according to the third embodiment of the present invention.

FIG. 9E is a graph showing defocus characteristics of contrasts in the optical device 1200 according to the third embodiment of the present invention.

FIG. 9F is a graph showing defocus characteristics of contrasts in the optical device 1200 according to the third embodiment of the present invention.

FIG. 10 is a cross-sectional view illustrating a main part of an image forming apparatus 5 on which the optical device according to any one of the first to third embodiments of the present invention is mounted.

FIG. 11 is a cross-sectional view illustrating a main part of a color image forming apparatus 33 on which the optical device according to any one of the first to third embodiments of the present invention is mounted.

### DESCRIPTION OF EMBODIMENTS

Now, an optical device according to embodiments of the present invention is described with reference to the drawings. Note that, some of the drawings are scaled differently from the actual scales for the sake of easy understanding of the present invention.

### First Embodiment

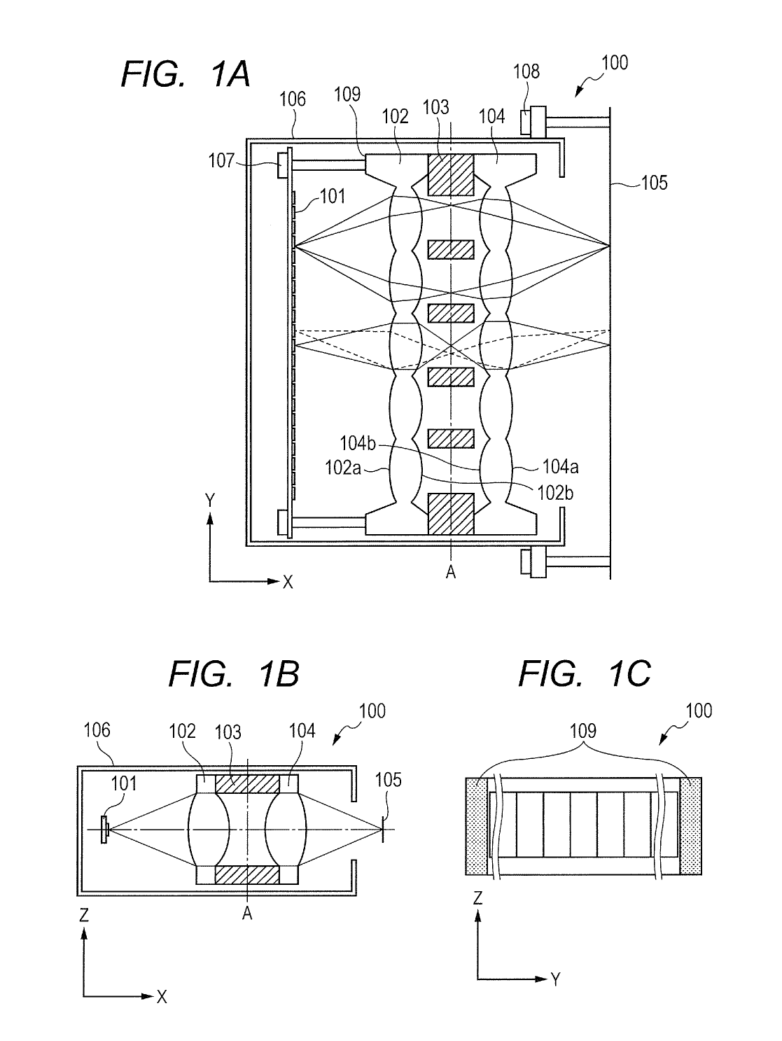

FIGS. 1A to 1C are schematic views illustrating a main part of an optical device 100 according to a first embodiment of the present invention. FIG. 1A is an XY cross-sectional view, FIG. 1B is an XZ cross-sectional view, and FIG. 1C is a YZ cross-sectional view.

The optical device 100 includes a light source 101, an imaging unit (imaging optical system) 102, a light blocking unit 103, an imaging unit (imaging optical system) 104, a light receiving surface (light receiving means) 105, a housing 106, and distance changing means (distance changing unit) 107 and 108.

The light source 101 is constructed by arraying multiple light-emitting points at regular intervals in a Y direction (first direction). An LED, an organic EL element (organic light emitting element), a laser, or the like may be used for each of the light-emitting points.

Each of the imaging units 102 and 104 is an MLA constructed by arraying multiple lens units at regular intervals in the Y direction perpendicular to an optical axis. The imaging units 102 and 104 are formed into the same shape and arranged so as to be symmetrical across a YZ plane. In each of the imaging units 102 and 104, a single lens array in which multiple lens units having the same shape are arrayed at regular intervals in the Y direction is provided in a Z direction (second direction perpendicular to the optical axis (X direction) and the Y direction). In this case, each of lens surfaces 102a and 102b of the imaging unit 102 and lens surfaces 104a and 104b of the imaging unit 104 has an anamorphic aspherical shape.

The light blocking unit 103 is provided with multiple opening portions. Within an XY cross-sectional plane, the light blocking unit 103 allows imaging light beams to pass therethrough and blocks non-imaging stray light beams among light beams passing through the imaging unit 102. As a specific structure, the light blocking unit 103 has multiple opening portions passing therethrough in the optical axis direction, and the centers of the opening portions are positioned on the optical axes of the lens units of the lens array of the imaging unit, respectively. In the Y direction, the wall between adjacent opening portions is positioned at a boundary portion between the lens units of the lens array.

An image of the light source 101 is formed through the imaging units 102 and 104 on the light receiving surface 105, which is arranged on the image side of the light source 101 across the imaging units 102 and 104. The light receiving surface (light receiving unit) 105 receives the light beams from the light source 101. Note that, when the optical device 100 is applied in an image forming apparatus, a photosensitive body such as a photosensitive drum is arranged on the light receiving surface 105. When the optical device 100 is applied in an image reading apparatus, an original (original table) extending in the Y direction (first direction) is arranged in place of the light source 101, and a light receiving sensor (line sensor) such as a CMOS sensor is arranged on the light receiving surface 105 in place of the photosensitive body.

The housing 106 houses the optical members such as the light source 101.

The distance changing means 107 (first distance changing means) is a member capable of adjusting a distance (first distance) in the optical axis direction between the light source 101 and the imaging unit 102 through rotation of screws, pins, or the like.

The distance changing means 108 (second distance changing means) is a member capable of adjusting a distance (second distance) in the optical axis direction between the housing 106 and the light receiving surface 105 through rotation of screws, pins, or the like.

Note that, the end portions of the distance changing means 107 on the light receiving surface 105 side are coupled to reference portions 109 of the imaging unit 102, respectively.

As illustrated in FIG. 1A, within the XY cross-sectional plane, each of the lens units of the imaging unit 102 condenses, on an intermediate imaging plane A, multiple light beams emitted from the multiple light-emitting points of the light source 101. The intermediate imaging plane A herein refers to an imaginary plane on which the imaging unit 102 forms an intermediate image of the light source 101 (object surface) (intermediately images the object surface), and is defined substantially at an intermediate position between the light source 101 and the light receiving surface (image surface) 105. Then, the light beams temporarily condensed on the intermediate imaging plane A enter each of the lens units of the imaging unit 104, and are further condensed on the light receiving surface 105. That is, an image from the intermediate image of the light source 101 is formed through the imaging unit 104 on the light receiving surface 105 (the intermediate image is formed again on the light receiving surface 105).

As described above, within the XY cross-sectional plane (first cross-sectional plane), the imaging units 102 and 104 of the optical device 100 according to this embodiment construct a system (erecting equal-magnification imaging system) configured to image the light-emitting point at equal magnification (first magnification) as an erecting image in the vicinity of the light receiving surface 105.

As illustrated in FIG. 1B, on the other hand, within an XZ cross-sectional plane (second cross-sectional plane), the imaging units 102 and 104 construct a system (inverted equal-magnification imaging system) configured to image the light-emitting point at equal magnification (second magnification) as an inverted image in the vicinity of the light receiving surface 105 without intermediately imaging the light-emitting point.

Note that, an infinite number of light beams are condensed by the imaging units 102 and 104 in actuality, but FIG. 1A illustrates only several characteristic light beams.

Table 1 shows various properties of the optical system of the optical device 100 according to this embodiment.

TABLE 1

| Structure | | | Aspherical shape | | | | | | | |
|---|---|---|---|---|---|---|---|---|---|---|
| Resolution | dpi | 600 | Surface 102a | | Surface 102b | | Surface 104b | | Surface 104a | |
| Wavelength | λ (nm) | 780 | R | 0 | R | 0 | R | 0 | R | 0 |
| Refractive index | nd | 1.492 | k | 0 | k | 0 | k | 0 | k | 0 |
| Fno of single lens in first direction | Fno_m | 3.90 | A20 | 0.50277 | A20 | −0.82549 | A20 | 0.82549 | A20 | −0.50277 |
| Fno of single lens in second direction | Fno_s | 1.30 | A40 | −0.51259 | A40 | 0.29164 | A40 | −0.29164 | A40 | 0.51259 |
| Magnification of single lens in first direction | βm | −0.45 | A60 | −0.24716 | A60 | −0.55971 | A60 | 0.55971 | A60 | 0.24716 |
| Magnification of entire system in first direction | β_all_m | 1 | A80 | 0.08357 | A80 | −0.01894 | A80 | 0.01894 | A80 | −0.08357 |
| Magnification of entire system in second direction | β_all_s | −1 | A100 | −6.91825 | A100 | −0.78249 | A100 | 0.78249 | A100 | 6.91825 |
| Array pitch of lenses in first direction | Pm (mm) | 0.76 | A02 | 0.15643 | A02 | −0.19504 | A02 | 0.19504 | A02 | −0.15643 |
| Number of lenses arrayed in first direction | Nm (piece) | 291 | A22 | −0.15873 | A22 | 0.09481 | A22 | −0.09481 | A22 | 0.15873 |
| Number of lenses arrayed in second direction | Ns (piece) | 1 | A42 | −0.15055 | A42 | −0.30023 | A42 | 0.30023 | A42 | 0.15055 |
| Size of light-emitting point in first direction | Dm (um) | 42.30 | A62 | 5.65920 | A62 | 3.06561 | A62 | −3.06561 | A62 | −5.65920 |
| Size of light-emitting point in second direction | Ds (um) | 25.40 | A82 | −13.83601 | A82 | −6.53977 | A82 | 6.53977 | A82 | 13.83601 |
| Aperture size | | | A04 | −0.03679 | A04 | −0.00756 | A04 | 0.00756 | A04 | 0.03679 |
| Aperture size of imaging unit 102 in first | Am1 (mm) | 0.76 | A24 | 0.14799 | A24 | 0.03211 | A24 | −0.03211 | A24 | −0.14799 |
| direction | | | | | | | | | | |
| Aperture size of imaging unit 102 in second | As1 (mm) | 2.44 | A44 | −1.03706 | A44 | −0.59005 | A44 | 0.59005 | A44 | 1.03706 |
| direction | | | | | | | | | | |
| Aperture size of imaging unit 104 in first | Am2 (mm) | 0.76 | A64 | −1.89450 | A64 | −0.69876 | A64 | 0.69876 | A64 | 1.89450 |
| direction | | | | | | | | | | |
| Aperture size of imaging unit 104 in second | As2 (mm) | 2.44 | A06 | 0.01270 | A06 | 0.00111 | A06 | −0.00111 | A06 | −0.01270 |
| direction | | | | | | | | | | |
| Aperture size of light blocking unit 103 in | Am3 (mm) | 0.66 | A26 | −0.07715 | A26 | −0.00101 | A26 | 0.00101 | A26 | 0.07715 |
| first direction | | | | | | | | | | |
| Aperture size of light blocking unit 103 in | As3 (mm) | 2.44 | A46 | 0.97142 | A46 | 0.41327 | A46 | −0.41327 | A46 | −0.97142 |
| second direction | | | | | | | | | | |
| Arrngement | | | A08 | −0.00611 | A08 | −0.00105 | A08 | 0.00105 | A08 | 0.00611 |
| Distance between light source 101 and | d1 (mm) | 2.65 | A28 | −0.01342 | A28 | −0.01827 | A28 | 0.01827 | A28 | 0.01342 |
| surface 102a | | | | | | | | | | |
| Distance between surface 102a and surface | d2 (mm) | 1.25 | A010 | 0.00128 | A010 | 0.00010 | A010 | −0.00010 | A010 | −0.00126 |
| 102b | | | | | | | | | | |
| Distance between surface 102b and surface | d3 (mm) | 2.16 | | | | | | | | |
| 104a | | | | | | | | | | |
| Distance between surface 104a and surface | d4 (mm) | 1.25 | | | | | | | | |
| 104b | | | | | | | | | | |
| Distance between surface 104b and light | d5 (mm) | 2.65 | | | | | | | | |
| receiving surface 105 | | | | | | | | | | |
| Thickness of light blocking unit 103 | d (mm) | 2.21 | | | | | | | | |

Assuming that an intersection between each of the lens surfaces 102a, 102b, 104a, and 104b and the optical axis is defined to be the origin, the aspherical shape of each of the lens surfaces is expressed by Expression (1).

$$x = \frac{\frac{{y}^{2} + {z}^{2}}{R}}{1 + \sqrt{1 - ( 1 + k ) {( \frac{\sqrt{{y}^{2} + {z}^{2}}}{R} )}^{2}}} + {\sum }_{i = 0}^{10} {\sum }_{j = 0}^{10} {A}_{ij} {y}^{2 i} {z}^{2 j} \qquad ( 1 )$$

In Expression (1), R represents a curvature radius, k represents a conic constant, and Aᵢⱼ (i=0, 1, 2, 3, 4, 5, . . . , 10, j=0, 1, 2, 3, 4, 5, . . . , 10) represents an aspherical coefficient.

Next, a mechanism of causing astigmatism due to a manufacturing error of each optical element is described.

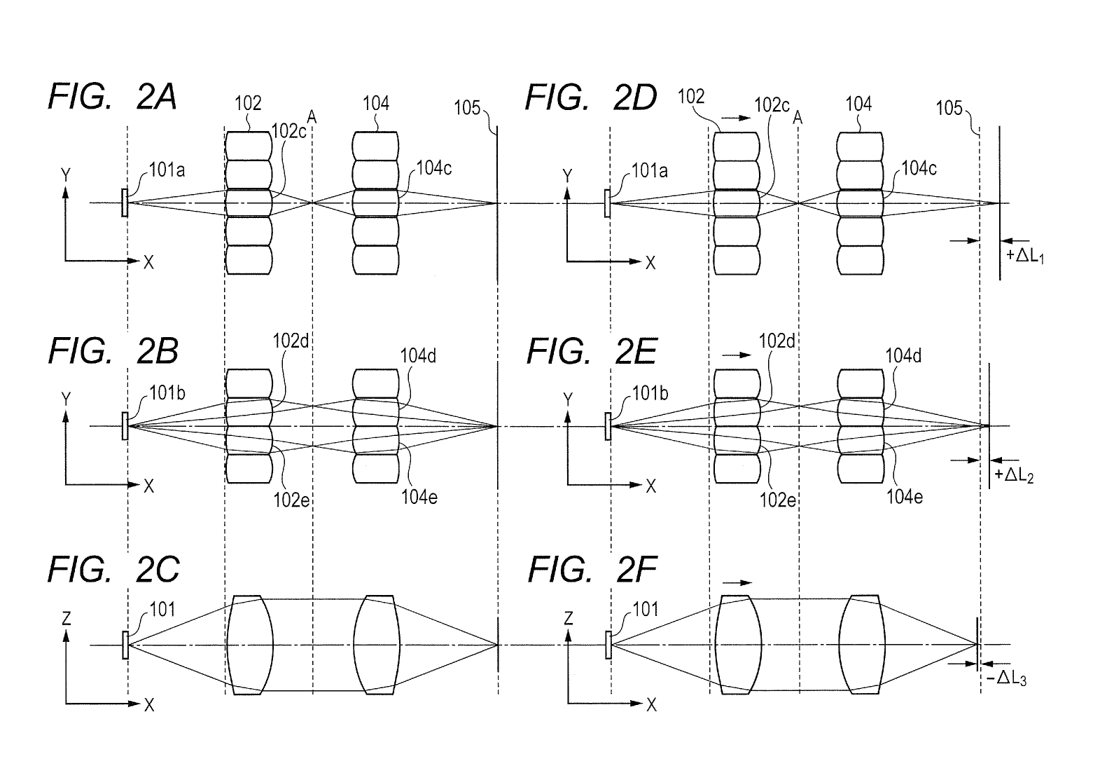

FIG. 2A is a view illustrating how a light-emitting point 101a positioned on optical axes of one lens 102c of the imaging unit 102 and one lens 104c of the imaging unit 104 (hereinafter referred to as “at an on-axis object height”) is imaged on the light receiving surface 105 within the XY cross-sectional plane under an ideal state.

FIG. 2B is a view illustrating how a light-emitting point 101b positioned on a straight line passing through intermediate positions between optical axes of two adjacent lenses 102d and 102e of the imaging unit 102 and two adjacent lenses 104d and 104e of the imaging unit 104 and parallel to the respective optical axes (hereinafter referred to as “at an intermediate object height”) is imaged on the light receiving surface 105 within the XY cross-sectional plane under the ideal state.

FIG. 2C is a view illustrating how the light-emitting point 101a or 101b at the on-axis object height or the intermediate object height is imaged on the light receiving surface 105 within the XZ cross-sectional plane under the ideal state.

FIG. 2D is a view illustrating how the light-emitting point 101a at the on-axis object height is imaged on the light receiving surface 105 within the XY cross-sectional plane in a case where the imaging unit 102 is displaced in a +X direction.

FIG. 2E is a view illustrating how the light-emitting point 101b at the intermediate object height is imaged on the light receiving surface 105 within the XY cross-sectional plane in the case where the imaging unit 102 is displaced in the +X direction.

FIG. 2F is a view illustrating how the light-emitting point 101a or 101b at the on-axis object height or the intermediate object height is imaged on the light receiving surface 105 within the XZ cross-sectional plane in the case where the imaging unit 102 is displaced in the +X direction.

First, how the light beams are imaged under the ideal state without any manufacturing error of each optical element is described with reference to FIGS. 2A to 2C.

In FIG. 2A, the light beam emitted from the light-emitting point 101a at the on-axis object height enters the lens 102c of the imaging unit 102, and is temporarily imaged on the intermediate imaging plane A. After that, the light beam enters the lens 104c of the imaging unit 104, and is maximally condensed in the vicinity of the light receiving surface 105.

Similarly, in FIG. 2B, the light beam emitted from the light-emitting point 101b at the intermediate object height enters the two adjacent lenses 102d and 102e of the imaging unit 102, and is temporarily imaged on the intermediate imaging plane A. After that, the light beam enters the two adjacent lenses 104d and 104e of the imaging unit 104, and is maximally condensed in the vicinity of the light receiving surface 105.

Further, in FIG. 2C, the light beam emitted from the light-emitting point 101a or 101b at the on-axis object height or the intermediate object height enters the lens of the imaging unit 102, and is output in the form of substantially collimated light. After that, the light beam enters the lens of the imaging unit 104, and is maximally condensed in the vicinity of the light receiving surface 105.

Note that, as illustrated in FIG. 2C, within the XZ cross-sectional plane, the light-emitting point 101a at the on-axis object height and the light-emitting point 101b at the intermediate object height exhibit the same behavior.

Next, how the light beams are imaged in the case where the imaging unit 102 is displaced toward the plus side in the optical axis direction (that is, in the +X direction) as the manufacturing error is described with reference to FIGS. 2D to 2F.

In FIG. 2D, the light beam emitted from the light-emitting point 101a at the on-axis object height enters the lens 102c of the imaging unit 102, and is temporarily imaged on a position displaced in the +X direction from the intermediate imaging plane A. After that, the light beam enters the lens 104c of the imaging unit 104, and is maximally condensed on a position displaced by +ΔL₁ from the light receiving surface 105.

Similarly, in FIG. 2E, the light beam emitted from the light-emitting point 101b at the intermediate object height enters the two adjacent lenses 102d and 102e of the imaging unit 102, and is temporarily imaged on a position displaced in the +X direction from the intermediate imaging plane A. After that, the light beam enters the two adjacent lenses 104d and 104e of the imaging unit 104, and is maximally condensed on a position displaced by +ΔL₂ from the light receiving surface 105. The reason why +ΔL₂ is smaller than +ΔL₁ is because the light beam passes through multiple lens units.

Further, in FIG. 2F, the light beam emitted from the light-emitting point 101a or 101b at the on-axis object height or the intermediate object height enters the lens of the imaging unit 102, and is output in the form of converging light. After that, the light beam enters the lens of the imaging unit 104, and is maximally condensed on a position displaced by −ΔL₃ from the light receiving surface 105.

Note that, as illustrated in FIG. 2F, also in the case where the imaging unit 102 is displaced in the +X direction, within the XZ cross-sectional plane, the light-emitting point 101a at the on-axis object height and the light-emitting point 101b at the intermediate object height exhibit the same behavior.

In the optical device 100 of this embodiment, when the imaging unit 102 is displaced by +0.020 mm in the +X direction, +ΔL₁ is +0.065 mm, +ΔL₂ is +0.023 mm, and −ΔL₃ is −0.020 mm.

Thus, when such a manufacturing error occurs that the imaging unit 102 is displaced in the optical axis direction (X direction), the position at which the light beam is maximally condensed differs between the XY cross-sectional plane and the XZ cross-sectional plane, resulting in astigmatism.

In the above description, astigmatism occurs when such a manufacturing error occurs that the imaging unit 102 is displaced in the optical axis direction. However, similar astigmatism may occur also due to manufacturing errors of other optical members.

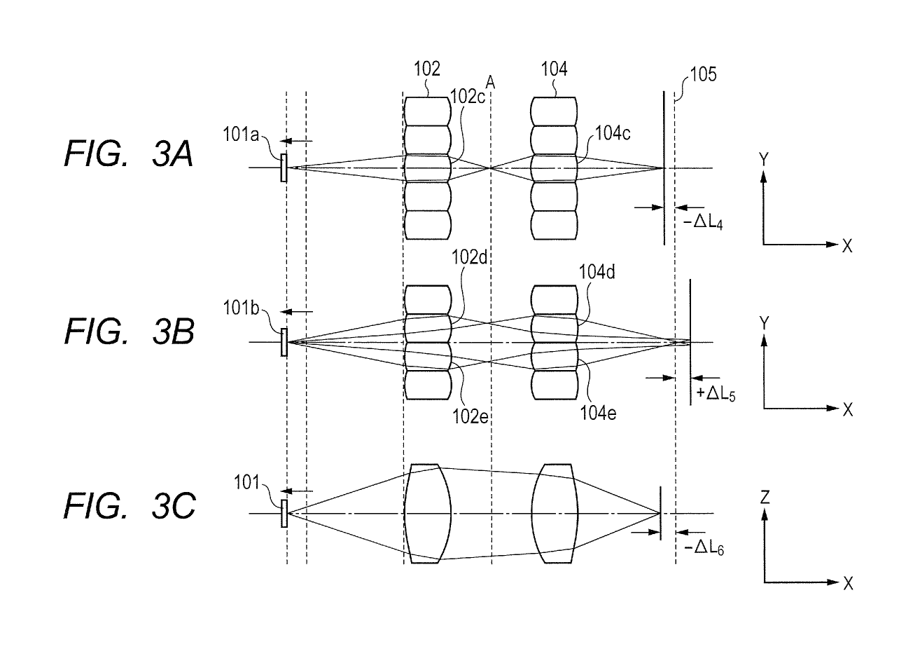

Next, how the light beams are imaged in a case where the light source 101 is displaced toward the minus side in the optical axis direction (that is, in a −X direction) as the manufacturing error is described with reference to FIGS. 3A to 3C.

FIG. 3A is a view illustrating how the light-emitting point 101a at the on-axis object height is imaged on the light receiving surface 105 within the XY cross-sectional plane in the case where the light source 101 is displaced in the −X direction.

FIG. 3B is a view illustrating how the light-emitting point 101b at the intermediate object height is imaged on the light receiving surface 105 within the XY cross-sectional plane in the case where the light source 101 is displaced in the −X direction.

FIG. 3C is a view illustrating how the light-emitting point 101a or 101b at the on-axis object height or the intermediate object height is imaged on the light receiving surface 105 within the XZ cross-sectional plane in the case where the light source 101 is displaced in the −X direction.

In FIG. 3A, the light beam emitted from the light-emitting point 101a at the on-axis object height enters the lens 102c of the imaging unit 102, and is temporarily imaged on a position displaced in the −X direction from the intermediate imaging plane A. After that, the light beam enters the lens 104c of the imaging unit 104, and is maximally condensed on a position displaced by −ΔL₄ from the light receiving surface 105.

Similarly, in FIG. 3B, the light beam emitted from the light-emitting point 101b at the intermediate object height enters the two adjacent lenses 102d and 102e of the imaging unit 102, and is temporarily imaged on the position displaced in the −X direction from the intermediate imaging plane A. After that, the light beam enters the two adjacent lenses 104d and 104e of the imaging unit 104, and is maximally condensed on a position displaced by +ΔL₅ from the light receiving surface 105. The reason why the light beam is maximally condensed on the position displaced in the +X direction from the light receiving surface 105 though the light beam is temporarily imaged on the position displaced in the −X direction from the intermediate imaging plane A is because the light beam passes through multiple lens units.

Further, in FIG. 3C, the light beam emitted from the light-emitting point 101a or 101b at the on-axis object height or the intermediate object height enters the lens of the imaging unit 102, and is output in the form of converging light. After that, the light beam enters the lens of the imaging unit 104, and is maximally condensed on a position displaced by −ΔL₆ from the light receiving surface 105.

Note that, as illustrated in FIG. 3C, also in the case where the light source 101 is displaced in the −X direction, within the XZ cross-sectional plane, the light-emitting point 101a at the on-axis object height and the light-emitting point 101b at the intermediate object height exhibit the same behavior.

In the optical device 100 of this embodiment, when the light source 101 is displaced by −0.020 mm in the −X direction, −ΔL₄ is −0.017 mm, +ΔL₅ is +0.016 mm, and −ΔL₆ is −0.020 mm.

Thus, it is found in this embodiment that astigmatism also occurs when the light source 101 is displaced in the optical axis direction.

In other words, it is found that, when the light source 101 is conversely displaced in the optical axis direction by intention, the astigmatism to be caused by the manufacturing error such as the above-mentioned displacement of the imaging unit 102 can be adjusted. That is, the distance changing means 107 changes the distance in the optical axis direction between the light source 101 and the imaging unit 102 so that the imaging position of the light source 101 through the imaging optical system within the XY cross-sectional plane and the imaging position of the light source 101 through the imaging optical system within the XZ cross-sectional plane coincide with each other. As a result, the astigmatism can be adjusted.

Next, a method of adjusting astigmatism to be caused by a manufacturing error is described.

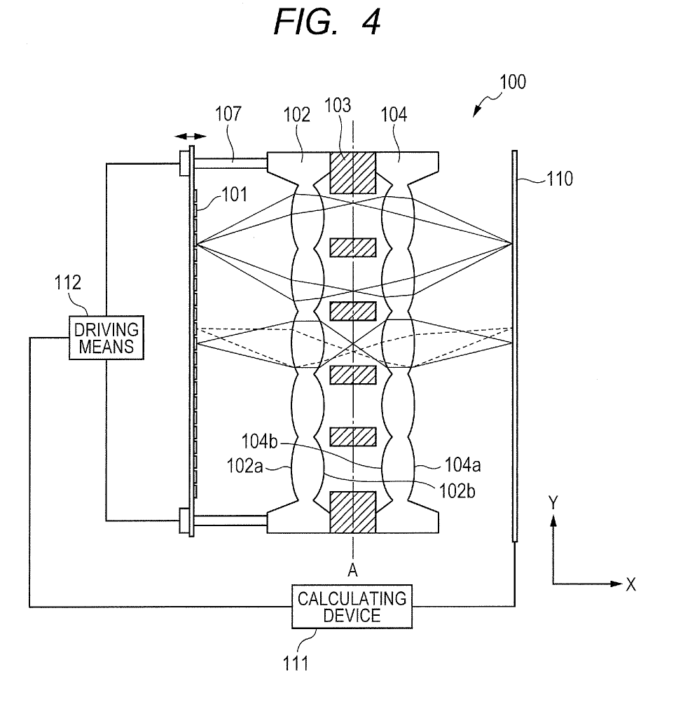

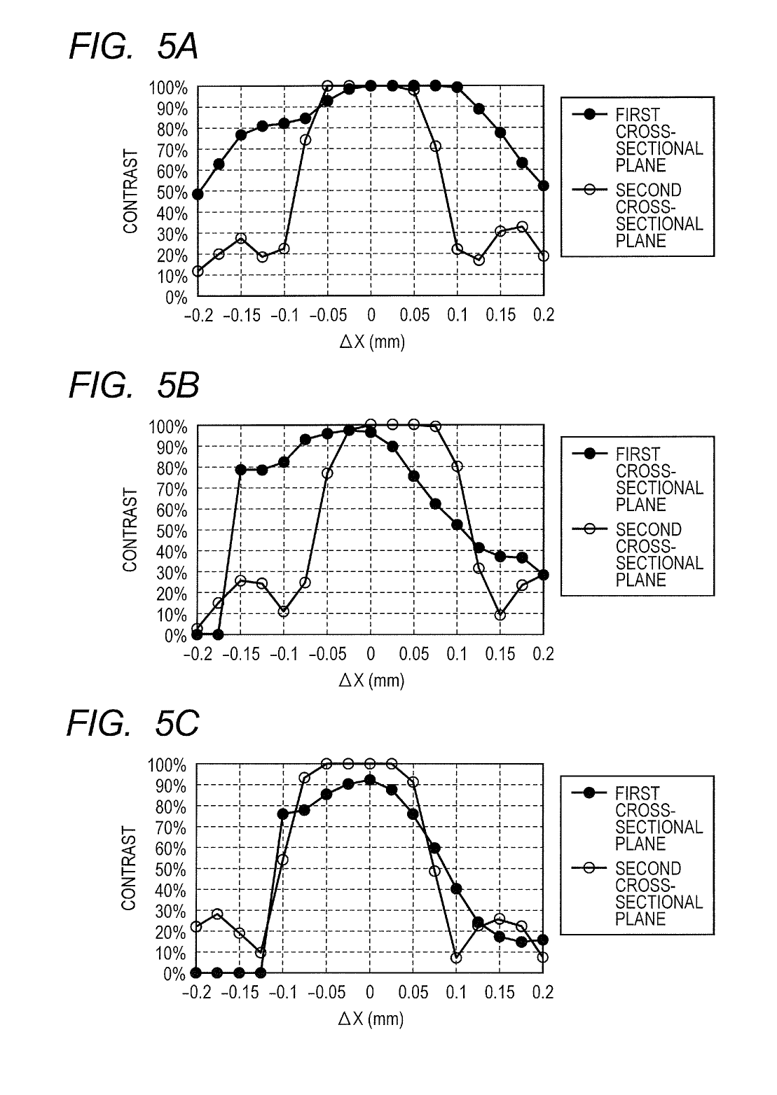

FIG. 4 is a schematic view illustrating a main part of the optical device 100 according to this embodiment, including means for adjusting astigmatism.

The means for adjusting astigmatism includes detecting means (detecting unit) 110, calculating means (calculating device) 111, and driving means 112.

The detecting means 110 is configured to detect formation of an image of the light beam emitted from the light source 101, and is arranged at a position on the light receiving surface 105.

The calculating means (calculating unit) 111 is connected to the detecting means 110, and is configured to calculate a movement amount of the distance changing means 107 for adjusting astigmatism based on a detection signal from the detecting means 110.

The driving means (driving unit) 112 is connected to the calculating means 111 and the distance changing means 107, and is configured to move the distance changing means 107 in the optical axis direction based on the calculation result of the calculating means 111, that is, the movement amount calculated by the calculating means 111.

In the optical device 100 according to this embodiment, the light emitted from the light source 101 such as an LED and an organic EL element passes through the imaging units 102 and 104, and enters the detecting means 110. The detecting means 110 inputs a detection signal of the incident light to the calculating means 111. Then, in response to displacement of the light source 101 in the optical axis direction by the driving means 112, the detecting means 110 acquires a detection signal of the incident light corresponding to each position of the light source 101, and inputs the detection signal to the calculating means 111. Based on the respective signals input from the detecting means 110, the calculating means 111 calculates the contrasts, spot diameters, peak light intensities, or the like within the XY cross-sectional plane and the XZ cross-sectional plane, to thereby determine an optimum position of the light source 101 at which the astigmatism is minimized. That is, the distance between the light source 101 and the imaging optical system is determined so that the imaging positions within the XY cross-sectional plane and the XZ cross-sectional plane coincide with each other in the optical axis direction, and thus the astigmatism can be suppressed. Based on the optimum position of the light source 101 determined by the calculating means 111, the driving means 112 moves the distance changing means 107 in the optical axis direction.

Specifically, when the calculating means 11 calculates the contrasts, the driving means 112 moves the distance changing means 107 in the optical axis direction so that the contrasts are maximized.

When the calculating means 111 calculates the spot diameters, the driving means 112 moves the distance changing means 107 in the optical axis direction so that the spot diameters are minimized.

When the calculating means 111 calculates the peak light intensities, the driving means 112 moves the distance changing means 107 in the optical axis direction so that the peak light intensities are maximized.

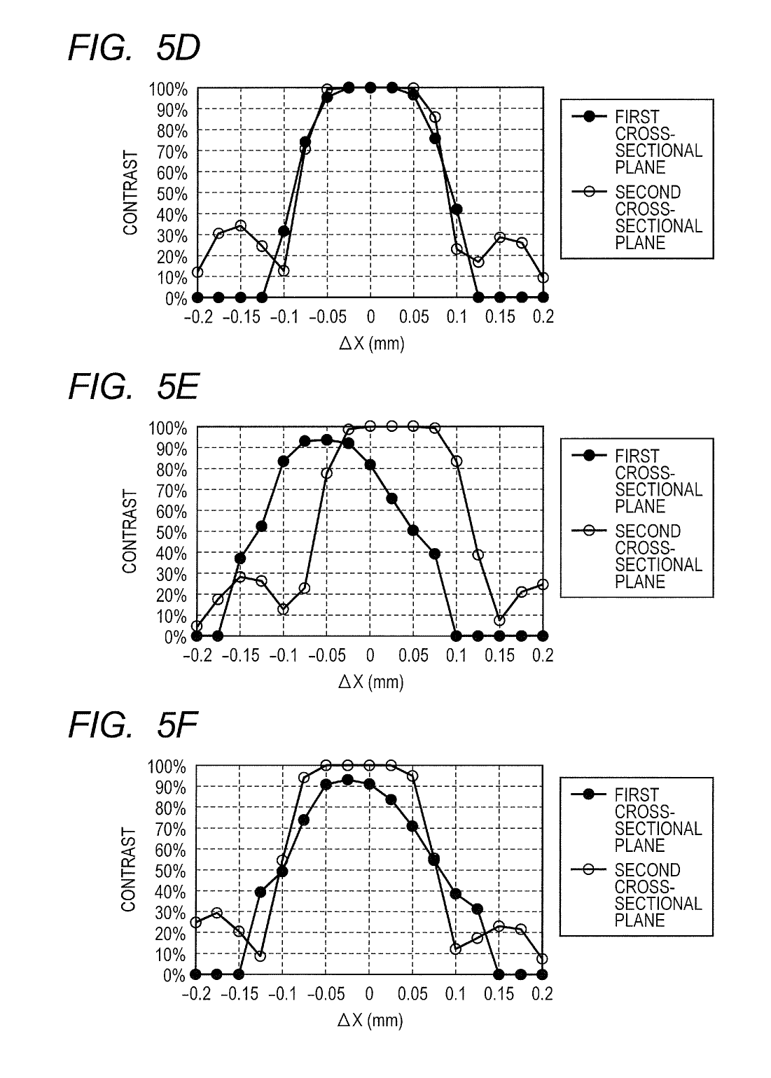

FIGS. 5A to 5F show defocus characteristics of the contrasts in the optical device 100 according to this embodiment.

FIG. 5A shows defocus characteristics of the contrasts for the light-emitting point at the on-axis object height under ideal design conditions.

FIG. 5B shows defocus characteristics of the contrasts for the light-emitting point at the on-axis object height in a case where the respective optical members are displaced as shown in Table 2 as the manufacturing error.

TABLE 2

| | Optical axis | First | Second |
|---|---|---|---|
| | direction | direction | direction |
| Light source | 0.01 | 0 | −0.04 |
| 101 | | | |
| Imaging unit | −0.0075 | 0.04 | 0.04 |
| 102 | | | |
| Imaging unit | 0.0075 | −0.04 | −0.04 |
| 104 | | | |
| Surface 102a | −0.005 | 0.005 | 0.005 |
| Surface 102b | −0.005 | −0.005 | −0.005 |
| Surface 104a | 0.005 | −0.005 | 0.005 |
| Surface 104b | −0.005 | 0.005 | −0.005 |
| | | | (mm) |

| | Surface | |
|---|---|---|
| | accuracy | |
| Newton error | −3 | fringe/φ10 mm |
| of surface | | |
| 102a | | |
| Newton error | −3 | fringe/φ10 mm |
| of surface | | |
| 102b | | |
| Newton error | −3 | fringe/φ10 mm |
| of surface | | |
| 104a | | |
| Newton error | −3 | fringe/φ10 mm |
| of surface | | |
| 104b | | |

FIG. 5C shows defocus characteristics of the contrasts for the light-emitting point at the on-axis object height in a case where the light source 101 is adjusted to the optimum position for the displacement of the respective optical members shown in Table 2 due to the manufacturing error.

FIG. 5D shows defocus characteristics of the contrasts for the light-emitting point at the intermediate object height under the ideal design conditions.

FIG. 5E shows defocus characteristics of the contrasts for the light-emitting point at the intermediate object height in the case where the respective optical members are displaced as shown in Table 2 as the manufacturing error.

FIG. 5F shows defocus characteristics of the contrasts for the light-emitting point at the intermediate object height in the case where the light source 101 is adjusted to the optimum position for the displacement of the respective optical members shown in Table 2 due to the manufacturing error.

Under the ideal design conditions, the astigmatism is 0 mm, and hence, as shown in FIG. 5A, the common depth range at the time when the contrast is 60% is 0.165 mm. On the other hand, in the case where the respective optical members are arranged with the displacement as shown in Table 2 due to the manufacturing error, astigmatism of 0.070 mm occurs, and hence, as shown in FIG. 5E, the common depth range at the time when the contrast is 60% becomes 0.092 mm.

When the distance changing means 107 moves the light source 101 by 0.040 mm in the optical axis direction so as to adjust the astigmatism, as shown in FIG. 5F, the common depth range at the time when the contrast is 60% can be recovered up to 0.156 mm.

Along with the adjustment of the astigmatism through the movement of the light source 101, the focusing can be adjusted by adjusting the distance between the housing 106 and the light receiving surface 105 through use of the distance changing means 108. Specifically, the distance between the housing 106 and the light receiving surface 105 is adjusted by 0.013 mm for the displacement of the respective optical members shown in Table 2.

As described above, in the optical device 100 according to the first embodiment of the present invention, the astigmatism to be caused by the manufacturing error can be adjusted through use of the distance changing means 107 and 108, and thus excellent imaging performance can be attained.

In this embodiment, each of the lens surfaces of the imaging units 102 and 104 of the optical device 100 has the anamorphic aspherical shape expressed by Expression (1), but the present invention is not limited thereto, and a similar effect may be attained even in a case of aspherical shapes expressed by other mathematical expressions.

Further, the optical device 100 of this embodiment has the structure in which two imaging units are arrayed in the optical axis direction, but the number of imaging units is not limited thereto, and a similar effect may be attained even in a case where a larger number of imaging units are arrayed.

Still further, in the optical device 100 of this embodiment, the optimum position of the light source 101 is determined based on the contrasts, but the present invention is not limited thereto. The optimum position may be determined based on the spot diameters. It is more preferred that the optimum position be calculated based on the peak light intensities so that the determination can be made simultaneously for the first and second directions. As a matter of course, the optimum position may be determined based not only on any one of the contrasts, the spot diameters, and the peak light intensities, but also on multiple parameters.

### Second Embodiment

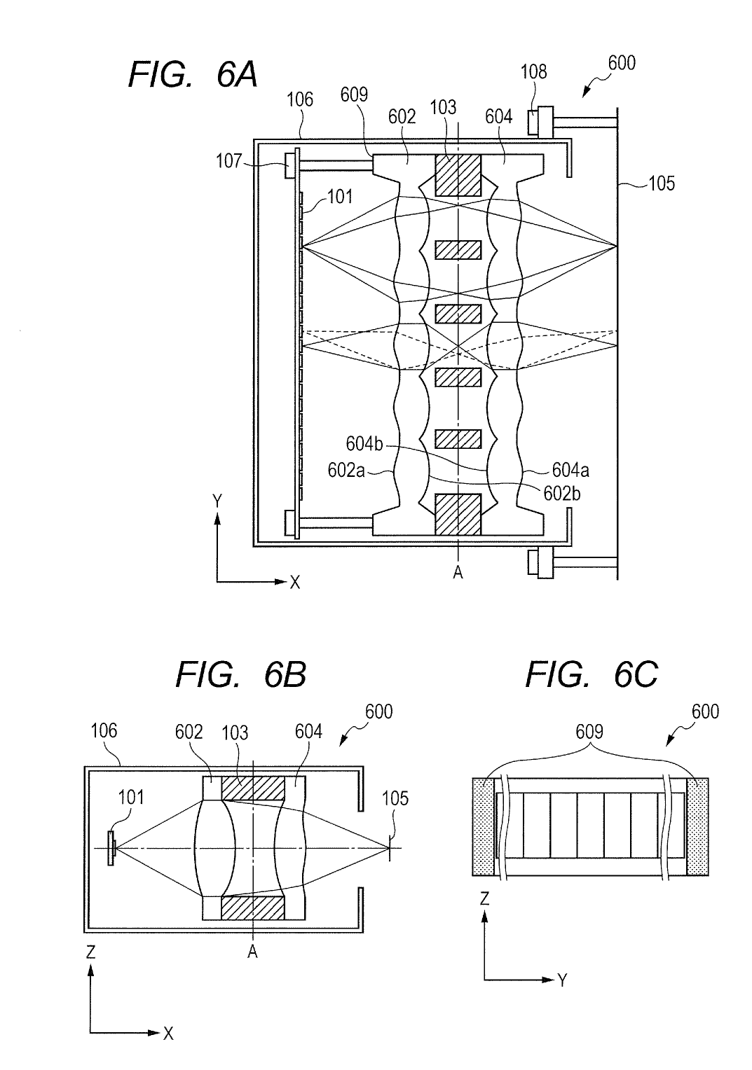

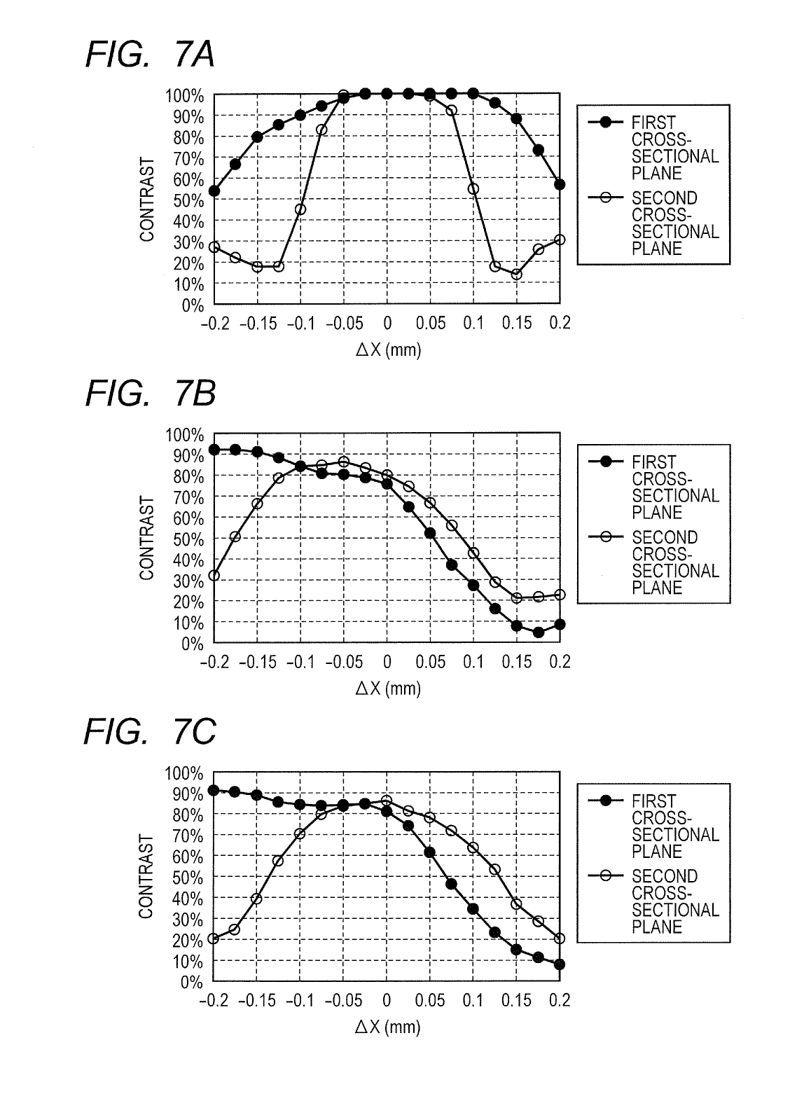

FIGS. 6A to 6C are schematic views illustrating a main part of an optical device 600 according to a second embodiment of the present invention. FIG. 6A is an XY cross-sectional view, FIG. 6B is an XZ cross-sectional view, and FIG. 6C is a YZ cross-sectional view.

The optical device 600 includes the light source 101, an imaging unit 602, the light blocking unit 103, an imaging unit 604, the light receiving surface (image surface) 105, the housing 106, and the distance changing means 107 and 108.

The light source 101, the light blocking unit 103, the light receiving surface 105, the housing 106, and the distance changing means 107 and 108 are similar to those of the first embodiment, and hence those components are represented by the same reference symbols to omit description thereof.

In the optical device 600 according to this embodiment, the lens units of the imaging unit 602 and the lens units of the imaging unit 604 have different shapes. Thus, in the optical device 600 according to this embodiment, the imaging unit 602, the light blocking unit 103, and the imaging unit 604 construct an enlarging system configured to image an object in an enlarged manner within the XZ cross-sectional plane.

Each of lens surfaces 602a and 602b of the imaging unit 602 and lens surfaces 604a and 604b of the imaging unit 604 has an anamorphic aspherical shape.

Table 3 shows various properties of the optical system of the optical device 600 according to this embodiment.

TABLE 3

| Structure | | | Aspherical shape | | | | | | | |
|---|---|---|---|---|---|---|---|---|---|---|
| Resolution | dpi | 600 | Surface 602a | | Surface 602b | | Surface 604a | | Surface 604b | |
| Wavelength | λ (nm) | 780 | R | 0 | R | 0 | R | 0 | R | 0 |
| Refractive index | nd | 1.492 | k | 0 | k | 0 | k | 0 | k | 0 |
| Fno of single lens in first direction | Fno_m | 3.90 | A20 | 0.49353 | A20 | −0.84151 | A20 | 0.84151 | A20 | −0.49353 |
| Fno of single lens in second direction | Fno_s | 1.20 | A40 | −0.51152 | A40 | 0.29629 | A40 | −0.29629 | A40 | 0.51152 |
| Magnification of single lens in first direction | βm | −0.45 | A60 | −0.58605 | A60 | −0.45822 | A60 | 0.45822 | A60 | 0.58605 |
| Magnification of entire system in first direction | β_all_m | 1 | A80 | 0.55114 | A80 | −2.30492 | A80 | 2.30492 | A80 | −0.055114 |
| Magnification of entire system in second direction | β_all_s | −1.3 | A100 | −6.18001 | A100 | 8.30369 | A100 | −8.30369 | A100 | 6.18001 |
| Array pitch of lenses in first direction | Pm (mm) | 0.76 | A02 | 0.20133 | A02 | −0.23125 | A02 | 0.19949 | A02 | −0.03519 |
| Number of lenses arrayed in first direction | Nm (piece) | 291 | A22 | −0.25709 | A22 | 0.10385 | A22 | −0.02678 | A22 | 0.14680 |
| Number of lenses arrayed in second direction | Ns (piece) | 1 | A42 | 0.03333 | A42 | −0.41981 | A42 | 0.22126 | A42 | 0.28788 |
| Size of light-emitting point in first direction | Dm (um) | 42.30 | A62 | 5.65825 | A62 | 3.25668 | A62 | −1.32747 | A62 | −2.40382 |
| Size of light-emitting point in second direction | Ds (um) | 25.40 | A82 | −11.79314 | A82 | −6.03053 | A82 | 1.49199 | A82 | 23.62346 |
| Aperture size | | | A04 | −0.02012 | A04 | 0.00680 | A04 | 0.00382 | A04 | 0.01535 |
| Aperture size of imaging unit 602 in first | Am1 (mm) | 0.76 | A24 | 0.16833 | A24 | 0.01902 | A24 | −0.07111 | A24 | −0.19636 |
| direction | | | | | | | | | | |
| Aperture size of imaging unit 602 in second | As1 (mm) | 2.44 | A44 | −0.85689 | A44 | −0.32633 | A44 | 0.61214 | A44 | 1.36064 |
| direction | | | | | | | | | | |
| Aperture size of imaging unit 604 in first | Am2 (mm) | 0.76 | A64 | −2.75367 | A64 | −1.71326 | A64 | 0.10789 | A64 | −5.64660 |
| direction | | | | | | | | | | |
| Aperture size of imaging unit 604 in second | As2 (mm) | 2.44 | A06 | 0.01283 | A06 | 0.00356 | A06 | 0.00032 | A06 | −0.00686 |
| direction | | | | | | | | | | |
| Aperture size of light blocking unit 103 in | Am3 (mm) | 0.66 | A26 | −0.02314 | A26 | −0.01182 | A26 | −0.01030 | A26 | 0.05265 |
| first direction | | | | | | | | | | |
| Aperture size of light blocking unit 103 in | As3 (mm) | 2.44 | A46 | 0.69981 | A46 | 0.41193 | A46 | −0.62041 | A46 | −2.47916 |
| second direction | | | | | | | | | | |
| Arrangement | | | A08 | 0.00714 | A08 | 0.00306 | A08 | −0.00070 | A08 | −0.01322 |
| Distance between light source 101 and | d1 (mm) | 2.62 | A28 | −0.00717 | A28 | 0.02039 | A28 | 0.02811 | A28 | −0.01344 |
| surface 602a | | | | | | | | | | |
| Distance between surface 602a and surface | d2 (mm) | 1.27 | A010 | −0.00170 | A010 | 0.00340 | A010 | 0.00348 | A010 | 0.02919 |
| 602b | | | | | | | | | | |
| Distance between surface 602b and surface | d3 (mm) | 2.16 | | | | | | | | |
| 604a | | | | | | | | | | |
| Distance between surface 604a and surface | d4 (mm) | 1.27 | | | | | | | | |
| 604b | | | | | | | | | | |
| Distance between surface 604b and light | d5 (mm) | 2.62 | | | | | | | | |
| receiving surface 105 | | | | | | | | | | |
| Thickness of light blocking unit 103 | d (mm) | 2.21 | | | | | | | | |

Assuming that an intersection between each of the lens surfaces 602a, 602b, 604a, and 604b and the optical axis is defined to be the origin, the aspherical shape of each of the lens surfaces is expressed by Expression (1).

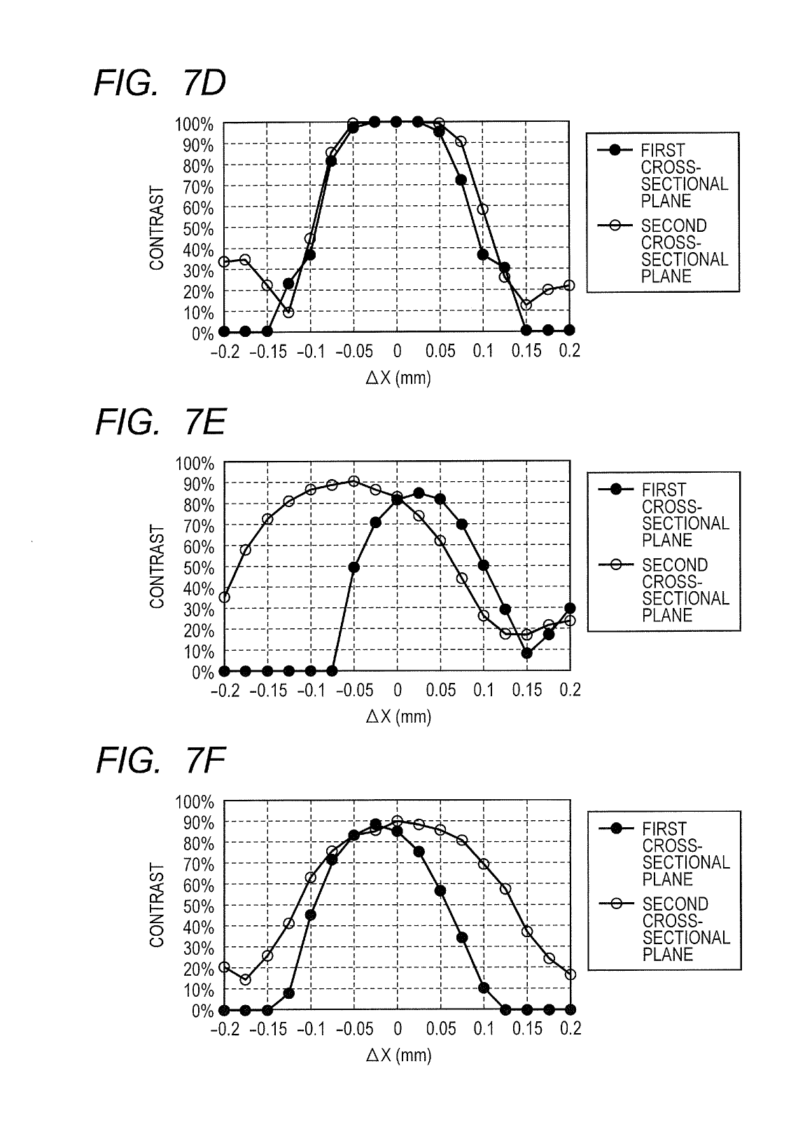

FIGS. 7A to 7F show defocus characteristics of the contrasts in the optical device 600 according to this embodiment.

FIG. 7A shows defocus characteristics of the contrasts for the light-emitting point at the on-axis object height under ideal design conditions.

FIG. 7B shows defocus characteristics of the contrasts for the light-emitting point at the on-axis object height in a case where the respective optical members are displaced as shown in Table 4 as the manufacturing error.

TABLE 4

| | Optical axis | First | Second |
|---|---|---|---|
| | direction | direction | direction |
| Light source | −0.045 | 0 | −0.04 |
| 101 | | | |
| Imaging unit | −0.0075 | 0.02 | 0.04 |
| 602 | | | |
| Imaging unit | 0.075 | −0.02 | −0.04 |
| 604 | | | |
| Surface 602a | −0.005 | 0.005 | 0.005 |
| Surface 602b | −0.005 | −0.005 | −0.005 |
| Surface 604a | 0.005 | −0.005 | 0.005 |
| Surface 604b | −0.005 | 0.005 | −0.005 |
| | | | (mm) |

| | Surface | |
|---|---|---|
| | accuracy | |
| Newton error | −3 | fringe/φ10 mm |
| of surface | | |
| 602a | | |
| Newton error | −3 | fringe/φ10 mm |
| of surface | | |
| 602b | | |
| Newton error | −3 | fringe/φ10 mm |
| of surface | | |
| 604a | | |
| Newton error | −3 | fringe/φ10 mm |
| of surface | | |
| 604h | | |

FIG. 7C shows defocus characteristics of the contrasts for the light-emitting point at the on-axis object height in a case where the light source 101 is adjusted to the optimum position for the displacement of the respective optical members shown in Table 4 due to the manufacturing error.

FIG. 7D shows defocus characteristics of the contrasts for the light-emitting point at the intermediate object height under the ideal design conditions.

FIG. 7E shows defocus characteristics of the contrasts for the light-emitting point at the intermediate object height in the case where the respective optical members are displaced as shown in Table 4 as the manufacturing error.

FIG. 7F shows defocus characteristics of the contrasts for the light-emitting point at the intermediate object height in the case where the light source 101 is adjusted to the optimum position for the displacement of the respective optical members shown in Table 4 due to the manufacturing error.

Under the ideal design conditions, the astigmatism is 0 mm, and hence, as shown in FIG. 7A, the common depth range at the time when the contrast is 60% is 0.170 mm. On the other hand, in the case where the respective optical members are arranged with the displacement as shown in Table 4 due to the manufacturing error, astigmatism of 0.085 mm occurs, and hence, as shown in FIG. 7E, the common depth range at the time when the contrast is 60% becomes 0.090 mm.

When the distance changing means 107 moves the light source 101 by 0.025 mm in the optical axis direction so as to adjust the astigmatism, as shown in FIG. 7F, the common depth range at the time when the contrast is 60% can be recovered up to 0.132 mm.

Along with the adjustment of the astigmatism through the movement of the light source 101, the focusing can be adjusted by adjusting the distance between the housing 106 and the light receiving surface 105 through use of the distance changing means 108. Specifically, the distance between the housing 106 and the light receiving surface 105 is adjusted by −0.033 mm for the displacement of the respective optical members shown in Table 4.

As described above, also in the optical device 600 according to the second embodiment of the present invention, including the imaging units 602 and 604 that construct the enlarging system, the astigmatism to be caused by the manufacturing error can be adjusted, and thus excellent imaging performance can be attained.

### Third Embodiment

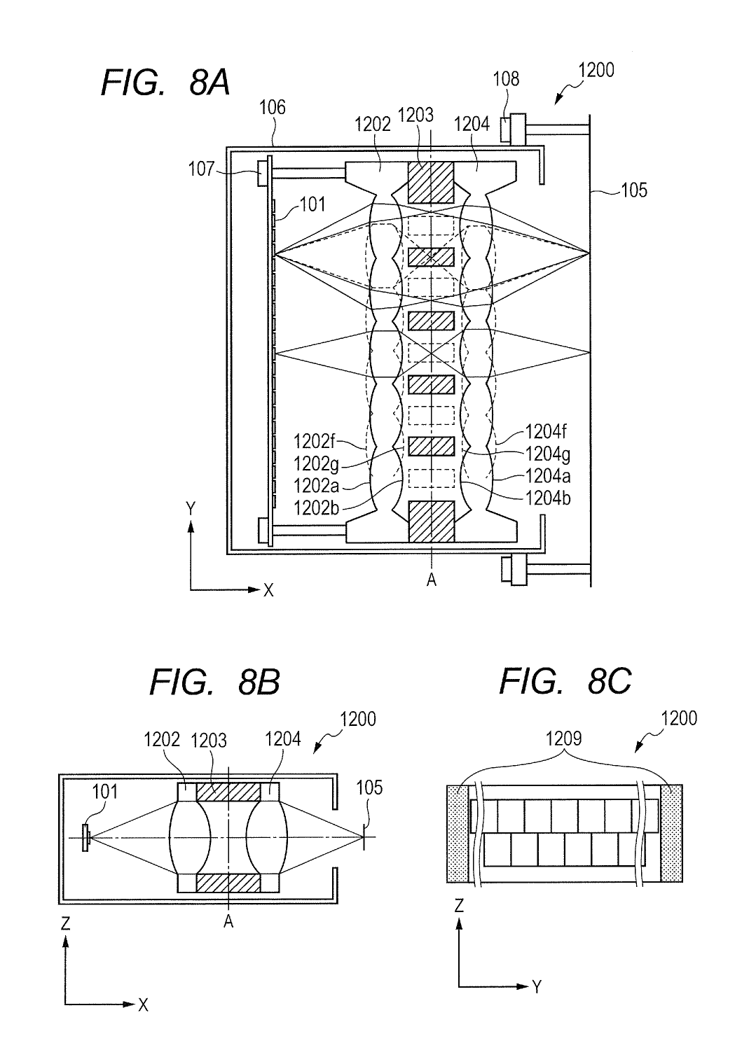

FIGS. 8A to 8C are schematic views illustrating a main part of an optical device 1200 according to a third embodiment of the present invention. FIG. 8A is an XY cross-sectional view, FIG. 8B is an XZ cross-sectional view, and FIG. 8C is a YZ cross-sectional view.

The optical device 1200 includes the light source 101, an imaging unit 1202, a light blocking unit 1203, an imaging unit 1204, the light receiving surface (image surface) 105, the housing 106, and the distance changing means 107 and 108.

The light source 101, the light receiving surface 105, the housing 106, and the distance changing means 107 and 108 are similar to those of the first embodiment, and hence those components are represented by the same reference symbols to omit description thereof.

In each of the imaging units 1202 and 1204 of the optical device 1200 according to this embodiment, two lens arrays in which multiple lens units having the same shape are arrayed at regular intervals in the Y direction are provided in the Z direction. As illustrated in FIG. 8C, the two lens arrays of each of the imaging units 1202 and 1204 are obtained by dividing the lens array of each of the imaging units of the first embodiment in the Z direction, and shifting the divided lens arrays in the Y direction by a half of the array interval of the lens units (half pitch). Note that, the imaging unit 1202 and the imaging unit 1204 are arranged so as to be symmetrical in the optical axis direction.

Further, each of lens surfaces 1202a, 1202b, 1202f, and 1202g of the lens units of the imaging unit 1202 and lens surfaces 1204a, 1204b, 1204f, and 1204g of the lens units of the imaging unit 1204 has an anamorphic aspherical shape.

Table 5 shows various properties of the optical system of the optical device 1200 according to this embodiment.

TABLE 5

| Structure | | | Aspherical shape | | | | | | | |
|---|---|---|---|---|---|---|---|---|---|---|
| Resolution | dpi | 600 | Surface | | Surface | | Surface | | Surface | |
| | | | 1202a, 1202f | | 1202b, 1202g | | 1204b, 1204g | | 1204a, 1204f | |
| Wavelength | λ (nm) | 780 | R | 0 | R | 0 | R | 0 | R | 0 |
| Refractive index | nd | 1.492 | k | 0 | k | 0 | k | 0 | k | 0 |
| Fno of single lens in first direction | Fno_m | 3.90 | A20 | 0.50277 | A20 | −0.82549 | A20 | 0.82549 | A20 | −0.50277 |
| Fno of single lens in second direction | Fno_s | 1.30 | A40 | −0.51259 | A40 | 0.29164 | A40 | −0.29164 | A40 | 0.51259 |
| Magnification of single lens in first direction | βm | −0.45 | A60 | −0.24716 | A60 | −0.55971 | A60 | 0.55971 | A60 | 0.24716 |
| Magnification of entire system in first direction | β_all_m | 1 | A80 | 0.08357 | A80 | −0.001894 | A80 | 0.01894 | A80 | −0.08357 |
| Magnification of entire system in second direction | β_all_s | −1 | A100 | −6.91825 | A100 | −0.78249 | A100 | 0.78249 | A100 | 6.91825 |
| Array pitch of lenses in first direction | Pm (nm) | 0.76 | A02 | 0.15643 | A02 | −0.19504 | A02 | 0.19504 | A02 | −0.15643 |
| Number of lenses arrayed in first direction | Nm (piece) | 291 | A22 | −0.15873 | A22 | 0.09481 | A22 | −0.09481 | A22 | 0.15873 |
| Number of lenses arrayed in second direction | Ns (piece) | 1 | A42 | −0.15055 | A42 | −0.30023 | A42 | 0.30023 | A42 | 0.15055 |
| Size of light-emitting point in first direction | Dm (um) | 42.30 | A62 | 5.65920 | A62 | 3.06561 | A62 | −3.06561 | A62 | −5.65920 |
| Size of light-emitting point in second direction | Ds (um) | 25.40 | A82 | −13.83601 | A82 | −6.53977 | A82 | 6.53977 | A82 | 13.83601 |
| Aperture size | | | A04 | −0.03679 | A04 | −0.00756 | A04 | 0.00756 | A04 | 0.03679 |
| Aperture size of imaging unit 1202 in first | Am1 (mm) | 0.76 | A24 | 0.14799 | A24 | 0.03211 | A24 | −0.03211 | A24 | −0.14799 |
| direction | | | | | | | | | | |
| Aperture size of imaging unit 1202 in second | As1 (mm) | 2.44 | A44 | −1.03706 | A44 | −0.59005 | A44 | 0.59005 | A44 | 1.03706 |
| direction | | | | | | | | | | |
| Aperture size of imaging unit 1204 in first | Am2 (mm) | 0.76 | A64 | −1.89450 | A64 | −0.69876 | A64 | 0.69876 | A64 | 1.89450 |
| direction | | | | | | | | | | |
| Aperture size of imaging unit 1204 in second | As2 (mm) | 2.44 | A06 | 0.01270 | A06 | 0.00111 | A06 | −0.00111 | A06 | −0.01270 |
| direction | | | | | | | | | | |
| Aperture size of light blocking unit 1203 in | Am3 (mm) | 0.66 | A26 | −0.07715 | A26 | −0.00101 | A26 | 0.00101 | A26 | 0.07715 |
| first direction | | | | | | | | | | |
| Aperture size of light blocking unit 1203 in | As3 (mm) | 2.44 | A46 | 0.97142 | A46 | 0.41327 | A46 | −0.41327 | A46 | −0.97142 |
| second direction | | | | | | | | | | |
| Arrangement | | | A08 | −0.00611 | A08 | −0.00105 | A08 | 0.00105 | A08 | 0.00611 |
| Distance between light source 101 and | d1 (mm) | 2.65 | A28 | −0.01342 | A28 | −0.01827 | A28 | 0.1827 | A28 | 0.01342 |
| surface 1202a | | | | | | | | | | |
| Distance between surface 1202a and surface | d2 (mm) | 1.25 | A010 | 0.00128 | A010 | 0.00010 | A010 | −0.0010 | A010 | −0.00128 |
| 1202b | | | | | | | | | | |
| Distance between surface 1202b and surface | d3 (mm) | 2.16 | | | | | | | | |
| 1204a | | | | | | | | | | |
| Distance between surface 1204a and surface | d4 (mm) | 1.25 | | | | | | | | |
| 1204b | | | | | | | | | | |
| Distance between surface 1204b and light | d5 (mm) | 2.65 | | | | | | | | |
| receiving surface 105 | | | | | | | | | | |
| Thickness of light blocking unit 1203 | d (mm) | 2.21 | | | | | | | | |

Assuming that an intersection between each of the lens surfaces 1202a, 1202b, 1202f, 1202g, 1204a, 1204b, 1204f, and 1204g and the optical axis is defined to be the origin, the aspherical shape of each of the lens surfaces is expressed by Expression (1).

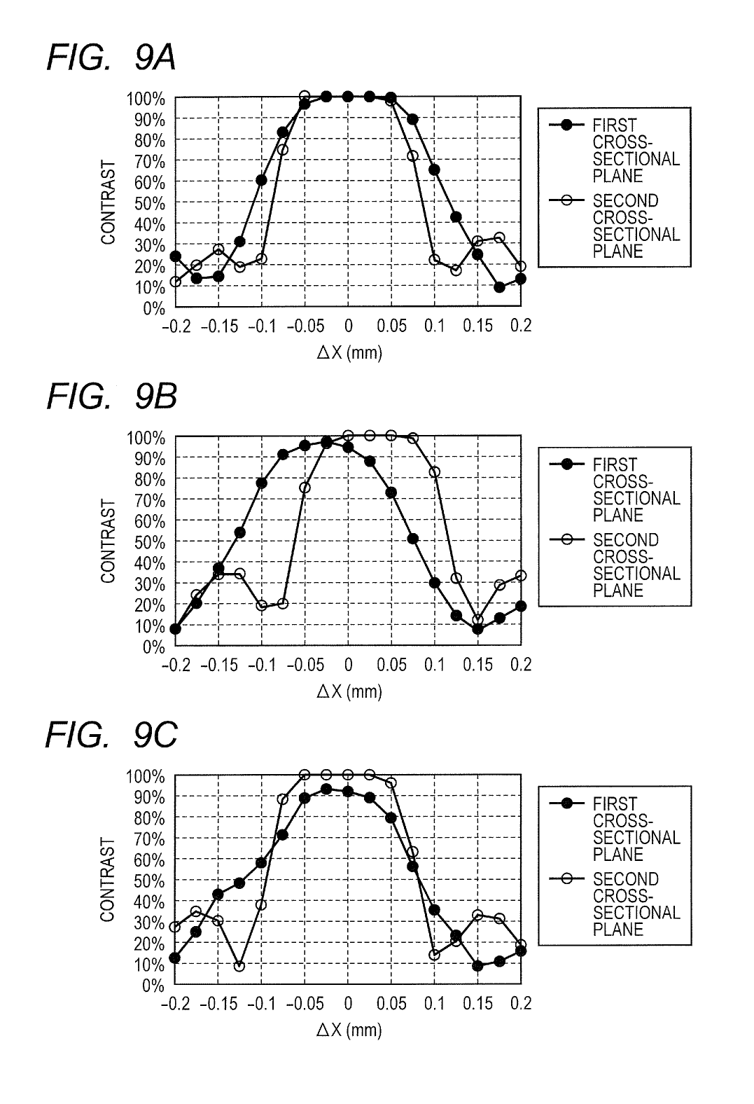

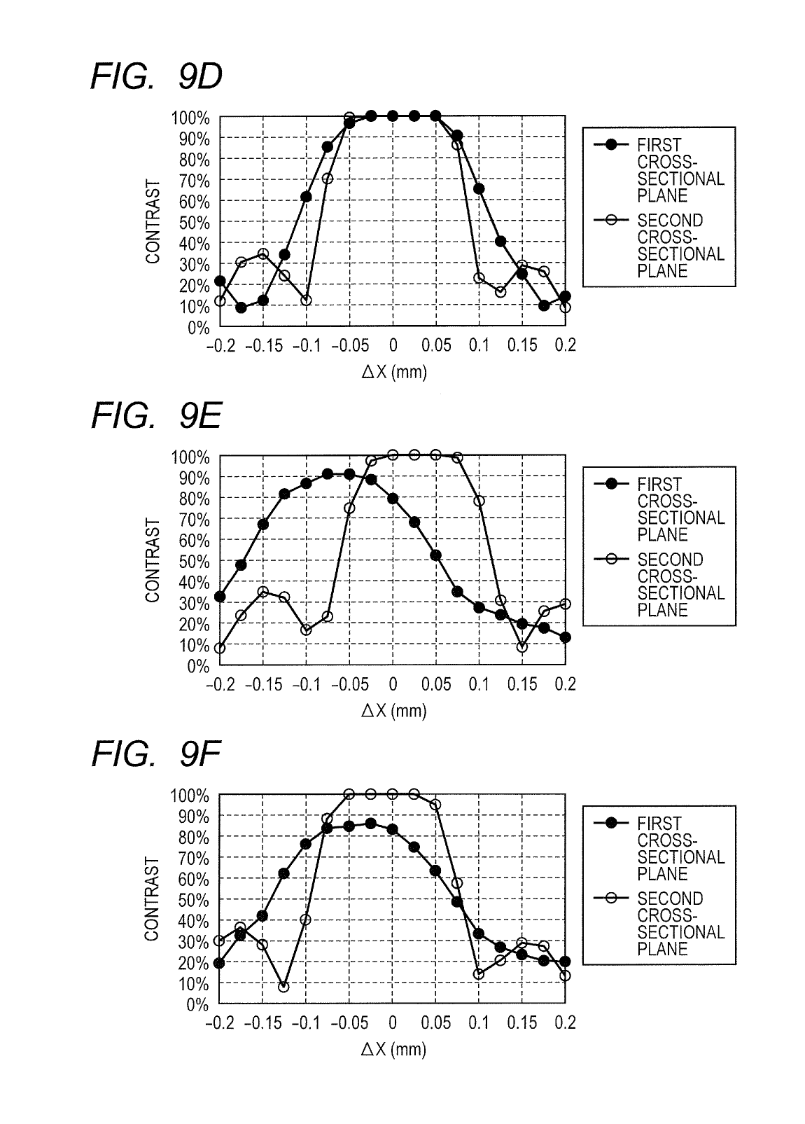

FIGS. 9A to 9F show defocus characteristics of the contrasts in the optical device 1200 according to this embodiment.

FIG. 9A shows defocus characteristics of the contrasts for the light-emitting point at the on-axis object height under ideal design conditions.

FIG. 9B shows defocus characteristics of the contrasts for the light-emitting point at the on-axis object height in a case where the respective optical members are displaced as shown in Table 6 as the manufacturing error.

TABLE 6

| | Optical axis | First | Second |
|---|---|---|---|
| | direction | direction | direction |
| Light source 101 | 0.01 | 0 | −0.04 |
| Imaging unit 1202 | −0.0075 | 0.04 | 0.04 |
| Imaging unit 1204 | 0.0075 | −0.04 | −0.04 |
| Surface 1202a | −0.005 | 0.006 | 0.005 |
| Surface 1202f | −0.005 | −0.006 | −0.005 |
| Surface 1202b | 0.005 | −0.006 | 0.005 |
| Surface 1204g | −0.005 | 0.006 | −0.005 |
| Surface 1204a | −0.005 | 0.005 | 0.005 |
| Surface 1204f | −0.005 | −0.005 | −0.005 |
| Surface 1204b | 0.005 | −0.005 | 0.005 |
| Surface 1204g | −0.005 | 0.005 | −0.005 |
| | | | (mm) |

| | Surface | |
|---|---|---|
| | accuracy | |
| Newton error of | −3 | fringe/φ10 mm |
| surface 1202a | | |
| Newton error of | −3 | fringe/φ10 mm |
| surface 1202b | | |
| Newton error of | −3 | fringe/φ10 mm |
| surface 1202f | | |
| Newton error of | −3 | fringe/φ10 mm |
| surface 1202g | | |
| Newton error of | −3 | fringe/φ10 mm |
| surface 1204a | | |
| Newton error of | −3 | fringe/φ10 mm |
| surface 1204b | | |
| Newton error of | −3 | fringe/φ10 mm |
| surface 1204f | | |
| Newton error of | −3 | fringe/φ10 mm |
| surface 1204g | | |

FIG. 9C shows defocus characteristics of the contrasts for the light-emitting point at the on-axis object height in a case where the light source 101 is adjusted to the optimum position for the displacement of the respective optical members shown in Table 6 due to the manufacturing error.

FIG. 9D shows defocus characteristics of the contrasts for the light-emitting point at the intermediate object height under the ideal design conditions.

FIG. 9E shows defocus characteristics of the contrasts for the light-emitting point at the intermediate object height in the case where the respective optical members are displaced as shown in Table 6 as the manufacturing error.

FIG. 9F shows defocus characteristics of the contrasts for the light-emitting point at the intermediate object height in the case where the light source 101 is adjusted to the optimum position for the displacement of the respective optical members shown in Table 6 due to the manufacturing error.

In this embodiment, the position of the light-emitting point at the intermediate object height is different from those of the above-mentioned first and second embodiments. Specifically, the light-emitting point at the intermediate object height is not arranged at the intermediate position between the optical axes of the two adjacent lenses in the first direction (Y direction), but is arranged at an intermediate position between optical axes of two adjacent lenses in the second direction (Z direction) within the XY cross-sectional plane. This is because, in this embodiment, the lens array of each of the imaging units is divided in the Z direction and the divided lens arrays are shifted by the half pitch.

Under the ideal design conditions, the astigmatism is 0 mm, and hence, as shown in FIG. 9A, the common depth range at the time when the contrast is 60% is 0.165 mm. On the other hand, in the case where the respective optical members are arranged with the displacement as shown in Table 6 due to the manufacturing error, astigmatism of 0.071 mm occurs, and hence, as shown in FIG. 9E, the common depth range at the time when the contrast is 60% becomes 0.094 mm.

When the distance changing means 107 moves the light source 101 by −0.125 mm in the optical axis direction so as to adjust the astigmatism, as shown in FIG. 9F, the common depth range at the time when the contrast is 60% can be recovered up to 0.145 mm.

Along with the adjustment of the astigmatism through the movement of the light source 101, the focusing can be adjusted by adjusting the distance between the housing 106 and the light receiving surface 105 through use of the distance changing means 108. Specifically, the distance between the housing 106 and the light receiving surface 105 is adjusted by −0.016 mm for the displacement of the respective optical members shown in Table 6.

As described above, also in the optical device 1200 according to the third embodiment of the present invention, including the imaging units 1202 and 1204 each including two lens arrays shifted by the half pitch in the Y direction, the astigmatism to be caused by the manufacturing error can be adjusted, and thus excellent imaging performance can be attained.

### Fourth Embodiment

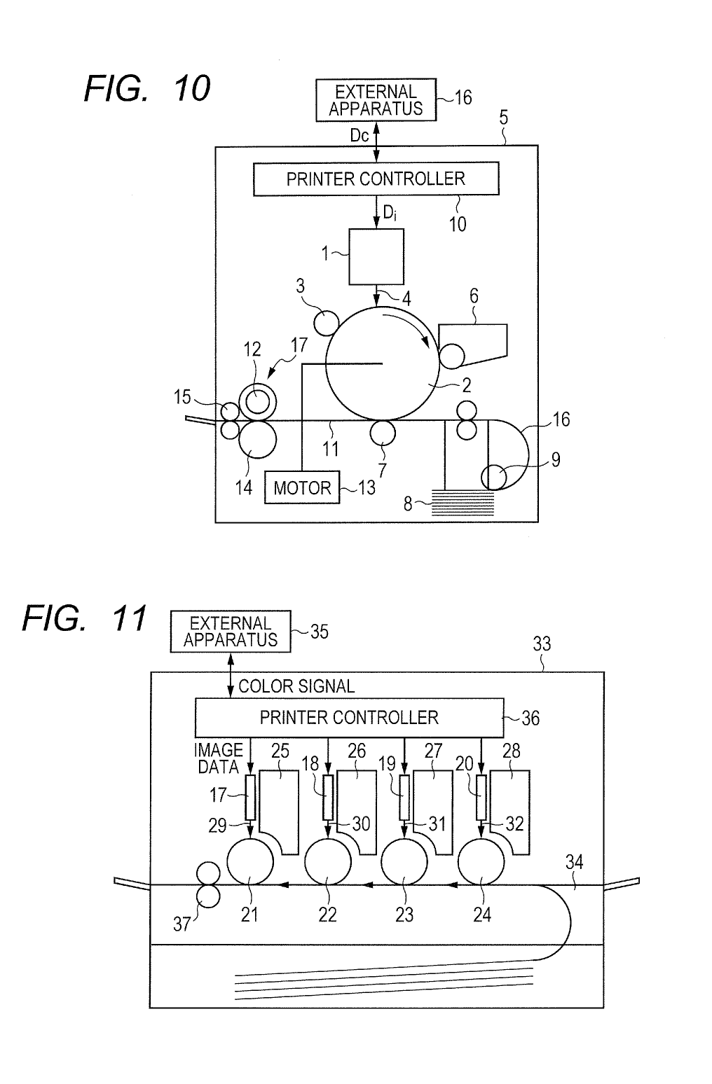

FIG. 10 is a cross-sectional view illustrating a main part of an image forming apparatus 5 on which the optical device according to any one of the first to third embodiments of the present invention is mounted.

Code data Dc is input from an external apparatus 16 such as a personal computer to the image forming apparatus 5. The code data Dc is converted into image data (dot data) Dᵢ by a printer controller 10 inside the image forming apparatus 5. The image data Dᵢ is input to an exposure unit 1 corresponding to the optical device according to any one of the first to third embodiments of the present invention. Then, the exposure unit 1 emits exposure light 4 modulated based on the image data Dᵢ, to thereby expose a photosensitive surface of a photosensitive drum 2 with the exposure light 4.

The photosensitive drum 2 serving as an electrostatic latent image bearing body (photosensitive body) is rotated clockwise by a motor 13. Along with the rotation, the photosensitive surface of the photosensitive drum 2 moves in the second direction relative to the exposure light 4. Above the photosensitive drum 2, a charging roller (charging means) 3 configured to uniformly charge the surface of the photosensitive drum 2 is provided in abutment against the surface. The exposure unit 1 is configured to radiate the exposure light 4 onto the surface of the photosensitive drum 2 that is charged by the charging roller 3.

As described above, the exposure light 4 is modulated based on the image data Dᵢ, and is radiated so as to form an electrostatic latent image on the surface of the photosensitive drum 2. The electrostatic latent image is developed into a toner image by a developing device (developing means) 6 arranged in abutment against the photosensitive drum 2 at a position on a downstream side in the rotational direction of the photosensitive drum 2 with respect to the irradiation position of the exposure light 4.

The toner image on the surface of the photosensitive drum 2, which is developed by the developing device (developing unit) 6, is transferred onto a sheet 11 serving as a recording medium by a transferring roller (transferring means, transferring unit) 7 arranged below the photosensitive drum 2 so as to be opposed to the photosensitive drum 2. The sheet 11 is received in a sheet cassette 8 arranged on a front side of the photosensitive drum 2 (right side in FIG. 10), and is fed to a conveyance path 16 by a sheet feeding roller 9. As a matter of course, the sheet may be fed from a manual feed tray (not shown).

The sheet 11 having the unfixed toner image transferred thereto from the photosensitive drum 2 is conveyed to a fixing device (fixing means) 17 arranged on a rear side of the photosensitive drum 2 (left side in FIG. 10). The fixing device (fixing unit) 17 includes a fixing roller 12 including a fixing heater (not shown) inside, and a pressure roller 14 arranged in press contact with the fixing roller 12. The fixing device 17 heats the conveyed sheet 11 while pressurizing the sheet 11 between the fixing roller 12 and the pressure roller 14, thereby being capable of fixing the unfixed toner image on the sheet 11. Sheet delivery rollers 15 are further arranged on a rear side of the fixing device 17, and are configured to deliver the sheet 11 after the fixing to the outside of the image forming apparatus 5.

Note that, the printer controller 10 is configured to control the respective units inside the image forming apparatus 5, such as the motor 13, as well as the data conversion.

### Fifth Embodiment

FIG. 11 is a cross-sectional view illustrating a main part of a color image forming apparatus 33 on which the optical device according to any one of the first to third embodiments of the present invention is mounted.

The color image forming apparatus 33 is a tandem-type color image forming apparatus corresponding to four colors, specifically, cyan (C), magenta (M), yellow (Y), and black (K). That is, the color image forming apparatus 33 includes exposure devices 17, 18, 19, and 20 each corresponding to the optical device according to any one of the first to third embodiments of the present invention. The color image forming apparatus 33 further includes photosensitive drums 21, 22, 23, and 24 each serving as an image bearing body, and developing devices 25, 26, 27, and 28.

Color signals of red (R), green (G), and blue (B) are input from an external apparatus 35 such as a personal computer to the color image forming apparatus 33. The color signals are converted into C, M, Y, and K image data (dot data) pieces by a printer controller 36 inside the color image forming apparatus 33. The image data pieces are input to the exposure devices 17, 18, 19, and 20, respectively. Then, the exposure devices 17, 18, 19, and 20 emit exposure light beams 29, 30, 31, and 32 modulated based on the image data pieces, to thereby expose charged photosensitive surfaces of the photosensitive drums 21, 22, 23, and 24 with the exposure light beams, respectively. Thus, electrostatic latent images are formed on the photosensitive surfaces, respectively.

The electrostatic latent images formed on the surfaces of the photosensitive drums 21, 22, 23, and 24 with the exposure light beams 29, 30, 31, and 32 are developed into C, M, Y, and K toner images by the developing devices 25, 26, 27, and 28, respectively.

A sheet 39 serving as a transfer material received in a sheet cassette 38 arranged on a front side of the photosensitive drums 21, 22, 23, and 24 (right side in FIG. 11) is fed along a conveyance path 34. Then, the color toner images developed on the photosensitive drums 21, 22, 23, and 24 are transferred onto the sheet 39 fed along the conveyance path 34 so as to be superimposed on each other sequentially.

The sheet 39 having the toner images transferred thereto is conveyed to a fixing device 37 arranged on a rear side of the photosensitive drums 21, 22, 23, and 24 (left side in FIG. 11), and is heated while being pressurized. Thus, the unfixed toner images are fixed onto the sheet 39. Then, the sheet 39 after the fixing is delivered to the outside of the color image forming apparatus 33.

As the external apparatus 35, for example, a color image reading apparatus including a CCD sensor may be used. In this case, the color image reading apparatus and the color image forming apparatus 33 construct a color digital copying machine. Further, the optical device according to any one of the first to third embodiments of the present invention may be used in the color image reading apparatus.

Further, the recording density of the image forming apparatus to be used in the present invention is not particularly limited. Considering that higher quality is required as the recording density becomes higher, however, the structure of the present invention exerts more advantageous effects in an image forming apparatus of 1,200 dpi or more.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-150264, filed Jul. 19, 2013, which is hereby incorporated by reference herein in its entirety.

### REFERENCE SIGNS LIST

101 light source
102 imaging unit
104 imaging unit
105 light receiving surface
107 distance changing means

1. An optical device, comprising:
an imaging optical system comprising multiple lens arrays in an optical axis direction, the multiple lens arrays each comprising multiple lens units arrayed in a first direction perpendicular to the optical axis direction;
a light source comprising multiple light-emitting points arrayed in the first direction; and
first changing means for changing a first distance in the optical axis direction between the light source and one of the multiple lens arrays, which is closest to the light source,
the imaging optical system being configured to:
image the light source at equal magnification as an erecting image within a first cross-sectional plane including the optical axis direction and the first direction; and
image, within a second cross-sectional plane perpendicular to the first direction, the light source at a magnification different from the magnification within the first cross-sectional plane.

2. The optical device according to claim 1, wherein the
imaging optical system is configured to image the light source as an inverted image within the second cross-sectional plane.

3. The optical device according to claim 1, wherein the imaging optical system is configured to image the light source at equal magnification as an inverted image within the second cross-sectional plane.

4. The optical device according to claim 1, wherein the imaging optical system is configured to image the light source in an enlarged manner within the second cross-sectional plane.

5. The optical device according to claim 1, wherein the imaging optical system comprises a light blocking unit having multiple openings corresponding to the multiple lens units, respectively.

6. The optical device according to claim 1, further comprising:
detecting means for receiving light from the imaging optical system;
calculating means for calculating, based on a signal corresponding to the light entering the detecting means, at least one of a contrast, a spot diameter, or a peak light intensity of the light entering the detecting means within at least one of the first cross-sectional plane or the second cross-sectional plane; and
driving means for driving the first changing means based on a calculation result from the calculating means.

7. The optical device according to claim 6, wherein the calculating means is configured to cause the first changing means to change the first distance so that an imaging position of the light source through the imaging optical system within the first cross-sectional plane and an imaging position of the light source through the imaging optical system within the second cross-sectional plane coincide with each other in the optical axis direction.

8. The optical device according to claim 7, wherein the calculating means is configured to cause the first changing means to change the first distance so that the contrast is maximized.

9. The optical device according to claim 7, wherein the calculating means is configured to cause the first changing means to change the first distance so that the spot diameter is minimized.

10. The optical device according to claim 7, wherein the calculating means is configured to cause the first changing means to change the first distance so that the peak light intensity is maximized.

11. An image forming apparatus, comprising:
an optical device;
developing means for developing an electrostatic latent image, which is formed on a surface of a photosensitive body by the optical device, into a toner image;
transferring means for transferring the toner image, which is developed by the developing means, onto a recording medium; and
fixing means for fixing the toner image, which is transferred by the transferring means, onto the recording medium,
wherein the optical device comprises:
an imaging optical system comprising multiple lens arrays in an optical axis direction, the multiple lens arrays each comprising multiple lens units arrayed in a first direction perpendicular to the optical axis direction;
a light source comprising multiple light-emitting points arrayed in the first direction; and
first changing means for changing a first distance in the optical axis direction between the light source and one of the multiple lens arrays, which is closest to the light source,
the imaging optical system being configured to:
image the light source at equal magnification as an erecting image within a first cross-sectional plane including the optical axis direction and the first direction; and
image, within a second cross-sectional plane perpendicular to the first direction, the light source at a magnification different from the magnification within the first cross-sectional plane.

12. The image forming apparatus according to claim 11, further comprising second changing means for changing a second distance between the photosensitive body and the imaging optical system so that an imaging position of the light source through the imaging optical system is arranged on the surface of the photosensitive body.

13. An image reading apparatus, comprising:
an optical device comprising:
an imaging optical system comprising multiple lens arrays in an optical axis direction, the multiple lens arrays each comprising multiple lens units arrayed in a first direction perpendicular to the optical axis direction;
an original table extending in the first direction, on which an original is to be placed; and
first changing means for changing a first distance in the optical axis direction between the original table and one of the multiple lens arrays, which is closest to the original table; and
light receiving means for receiving light from the imaging optical system,
the imaging optical system being configured to:
image the original at equal magnification as an erecting image within a first cross-sectional plane including the optical axis direction and the first direction; and
image, within a second cross-sectional plane perpendicular to the first direction, the original at a magnification different from the magnification within the first cross-sectional plane.

14. The image reading apparatus according to claim 13, further comprising second changing means for changing a second distance between the light receiving means and the imaging optical system so that an imaging position of the original through the imaging optical system coincides with a position of the light receiving means.

15. A method of manufacturing an optical device, the optical device comprising:
an imaging optical system comprising multiple lens arrays in an optical axis direction, the multiple lens arrays each comprising multiple lens units arrayed in a first direction perpendicular to the optical axis direction; and
a light source comprising multiple light-emitting points arrayed in the first direction,
the imaging optical system being configured to:
image the light source at equal magnification as an erecting image within a first cross-sectional plane including the optical axis direction and the first direction; and
image, within a second cross-sectional plane perpendicular to the first direction, the light source at a magnification different from the magnification within the first cross-sectional plane,
the method comprising changing a first distance in the optical axis direction between the light source and one of the multiple lens arrays, which is closest to the light source.

16. The method of manufacturing an optical device according to claim 15, wherein the changing comprises changing the first distance so that an imaging position of the light source through the imaging optical system within the first cross-sectional plane and an imaging position of the light source through the imaging optical system within the second cross-sectional plane coincide with each other in the optical axis direction.

17. The method of manufacturing an optical device according to claim 16, wherein the changing comprises changing the first distance so that a position within the first cross-sectional plane, at which a contrast of light from the imaging optical system is maximized, and a position within the second cross-sectional plane, at which the contrast of the light from the imaging optical system is maximized, coincide with each other in the optical axis direction.

18. The method of manufacturing an optical device according to claim 16, wherein the changing comprises changing the first distance so that a spot diameter of the light at the imaging position is minimized.

19. The method of manufacturing an optical device according to claim 16, wherein the changing comprises changing the first distance so that a peak light intensity of the light from the light source at the imaging position is maximized.
